(19) United States
(12) Patent Application Publication
(10) Pub. No.: US 2026/0257959 A1
(43) Pub. Date: Sep. 3, 2026

(54) UNIT AND METHOD FOR DETECTING THE POSITION OF A SHEET AND APPARATUS FOR WORKING SHEETS COMPRISING SAID POSITION DETECTION UNIT

(71) Applicant: Forel S.p.A., Roncade (IT)

(72) Inventors: Fortunato VIANELLO, Roncade (TV) (IT); Riccardo VIANELLO, Roncade (TV) (IT)

(21) Appl. No.: 18/875,259

(22) PCT Filed: Jun. 9, 2023
(86) PCT No.: PCT/IT2023/050142

§ 371 Date: Dec. 16, 2024

(30) Foreign Application Priority Data
Jun. 16, 2022 (IT) 102022000012761

(51) Int. Cl. C03B 33/037; G01B 11/02

(52) U.S. Cl. CPC C03B 33/037; G01B 11/028

(57) ABSTRACT

A positional detector for a sheet having a perimeter edge is described. The positional detector includes a slider and a detection device provided with a detection member.

### FIELD OF THE INVENTION

The present invention concerns a unit and a method for detecting the position of a pre-cut glass sheet which has to be subjected to subsequent working.

The invention also concerns an apparatus for working glass sheets comprising said position detection unit.

This apparatus is intended for the production of glass sheets for the building sector, both residential and commercial, for example, but not limited to, insulating glass sheets, glass walls and balustrades, for the furniture sector, for example parts of furniture, shower cubicles and other, for the transport sector, for example windows or fronts for automobiles, buses, trucks and trains, and for the naval sector, for example balustrades.

### BACKGROUND OF THE INVENTION

Apparatuses are known for working glass sheets which are first possibly pre-cut and then undergo further working, usually with the removal of material, in order to obtain a finished or semi-finished product.

It is also known that a sheet of glass can be “monolithic”, if it consists of a single glass panel, or “laminated” if it consists of the overlapping of two monolithic glass panels by interposing one or more membranes of plastic material, and finally “armored” if the number of overlapping glass panels is greater than two and membranes of plastic material are interspersed between them.

The sheets are obtained starting from cutting a larger unworked sheet, known to persons of skill in the art by the terms “Jumbo” or “Super Jumbo”, that is, having a rectangular shape of 6 m×3.21 m, or 9 m×3.21 m, even up to 18 m×3.5 m.

The process of cutting the unworked sheet to obtain a plurality of smaller sheets depends on the type of glass and in any case, but above all for monolithic and laminated glass, involves making, with special cutting tools, a single line of incision, in the case of a monolithic sheet, or a line of incision on each surface of the sheet, in the case of a laminated sheet, from which an irregular fracture is generated which defines the perimeter edge of the new sheet. Due to the particular mechanical characteristics of the glass and according to the typical paths of fracture mechanics, this perimeter edge has a first segment that is orthogonal to the surface where the incision line was made, and at least a second segment inclined with respect to the surfaces of the sheet. This development is known to persons of skill in the art by the term “shoe”.

Known apparatuses for working glass sheets normally comprise one or more units for moving the glass sheet, at least one work unit equipped with one or more tools which can carry out perimeter grinding, drilling, milling or other work, as well as a unit for detecting the position of the sheet configured to identify a reference on the perimeter edge of the sheet, subsequently used to position the sheet itself with respect to the work tool.

Examples of known apparatuses for working glass sheets are described in documents U.S. Pat. No. 10,702,966 B2 and EP 1.491.510 A2 in the name of the present Applicant. In particular, U.S. Pat. No. 10,702,966 B2 shows a position detection unit comprising a slider selectively movable in a direction of advance of the sheet and a support arm associated with the slider and having a prevalent extension along its own axis of development. The support arm is provided at the end with a fixed detection device which projects transversally from the support arm to interfere with the perimeter edge of the sheet, detecting its position.

One of the disadvantages of known position detection units is that they may not be able to correctly detect the orthogonal segment of the perimeter edge of the sheet and/or generic defects in shape present on the perimeter edge of the sheet and therefore they may not be able to correctly identify the incision line or in general the correct profile.

These position detection units are in fact equipped with mechanical, inductive, capacitive or optical sensors which, taking the edge of the glass sheet as a reference, identify the most protruding point in the thickness of the edge of the sheet which is at the level of the sensors and not the point belonging to the incision line. Because of this, the positioning of the glass sheet for subsequent working may be affected by errors.

The correct detection of the incision line and of any defects in shape present on the perimeter edge of the sheet also depends on the position in which the sheet is stopped for the detection operations. This position depends on the sensitivity of the proximity sensors and on the response of one or more units for moving the sheet to the signals of these sensors which occurs with variable reaction times since they depend, for example, on the variation (Jitter) of one or more characteristics of the input signal to the control unit of the apparatus, such as in particular the phase.

Furthermore, in the case of sheets of laminated glass, another obstacle to the correct detection of the incision line may be due to the portion of the membrane of plastic material which extends along the perimeter between the two glass panels.

The imprecise positioning of the sheet with respect to the work tool is a problem that is particularly serious, especially in the case of edge grinding working in which, in order to consider the errors of detection of the perimeter edge, it is necessary to remove a greater quantity of material. The consequences are an increase in the energy required for working, a decrease in the surface yield of the sheet and a correlated increase in working waste (glass dust) which, since it is discharged by means of a water filtering system, also imply an increase proportional to the costs correlated to it.

Document IT BS 20 110 171 A1 describes an apparatus for measuring the longitudinal extension of moving parts, for example glass sheets.

Document WO 2020/213452 A1 describes an apparatus for producing a glass sheet provided with a position detection device for detecting the position of a glass sheet.

Document JP 2014 087879 A describes a method for working a glass sheet which provides a step of acquiring information on the position of the glass sheet before its perimeter edge is worked.

There is therefore a need to perfect a unit and a method for detecting the position of a glass sheet, as well as an apparatus for working glass sheets comprising said position detection unit, which can overcome at least one of the disadvantages of the state of the art.

One purpose of the present invention is to prevent the position detection unit from interacting in correspondence with conformations of the perimeter edge of the glass sheet altered by singular macroscopic local imperfections.

Another purpose of the present invention, which corresponds to the technical problem to be solved, is to provide a position detection unit for a glass sheet which is also able to detect, in a particularly precise manner, the incision line used to pre-cut the sheet irrespective of the irregularities that characterize the edges of the sheet, the thickness of the sheet and any possible errors in the pre-positioning of the sheet with respect to the position detection unit.

Another purpose of the present invention is to provide a method for detecting the position of a glass sheet which is particularly simple, fast and accurate.

The Applicant has devised, tested and embodied the present invention to overcome the shortcomings of the state of the art and to obtain these and other purposes and advantages.

### SUMMARY OF THE INVENTION

The present invention is set forth and characterized in the independent claims. The dependent claims describe other characteristics of the present invention or variants to the main inventive idea.

In accordance with the above purposes, a position detection unit is described, according to the present invention, for a sheet having a perimeter edge. The unit comprises a slider, fixed or sliding, and a detection device provided with a detection member.

According to the present invention, the unit comprises an angular positioning actuator and a rotating table operatively connected to the angular positioning actuator and on which the detection member is mounted, the detection member being selectively positionable angularly in a first and second position of contact with the perimeter edge.

The first and second position of contact are at different work heights along the perimeter edge of the sheet.

Each work height is advantageously defined along a positioning axis transverse to a thickness of the sheet.

Alternatively, always according to the present invention, the unit comprises a linear positioning actuator to which the detection device is connected, the detection member being selectively positionable linearly in a position of contact, of a plurality of positions of contact, with the perimeter edge along a positioning axis.

The position of contact is at a work height along the positioning axis transverse to the thickness of the sheet.

The positioning axis is parallel to a direction in which the height of the sheet extends.

In accordance with another aspect of the present invention, the detection device, or the detection member, is able to be selectively moved along an adjustment axis transverse with respect to a direction of advance of the sheet.

In accordance with another aspect of the present invention, the unit comprises guides attached to the slider and corresponding sliding blocks attached to the detection device, which are parallel to the adjustment axis.

In accordance with another aspect of the present invention, the unit also comprises detection means disposed upstream of, or substantially in correspondence with, the detection device and configured both to detect the arrival of the sheet and also to detect a distance between the perimeter edge and the detection member.

In accordance with another aspect of the present invention, the unit comprises a control unit configured to control the movement of the detection member on the basis of the thickness of the sheet, of the position of at least one lateral surface of the sheet and optionally also of detection signals generated by the detection means.

In accordance with another aspect of the present invention, the angular positioning actuator is configured to determine a corrective angular commutation of the detection member on the basis of a correction signal generated by the control unit.

In accordance with another aspect of the present invention, the unit comprises image acquisition devices operatively connected to the control unit and configured to acquire and send images of the perimeter edge facing the detection member to the control unit. The control unit is in turn configured to process the images, identify any irregularities or defects and command the movement of the detection member into the correct position, that is, to the correct work height.

Some embodiments of the present invention also concern an apparatus for working a sheet comprising movement means configured to move at least one sheet at a time in a direction of advance, a work unit provided with a work tool configured to perform work on the sheet, and a position detection unit as above.

Some embodiments of the present invention also concern a method for detecting the position of a sheet having a perimeter edge, comprising:
a movement step, in which a sheet is made to advance in a direction of advance toward the position detection unit, or vice versa;
a detection step, in which the detection member is taken to temporarily interfere with the perimeter edge of the sheet.

According to the present invention, before or during the detection step, the detection member is selectively positioned angularly in a first or second position of contact with the perimeter edge at a desired work height transverse to the thickness of the sheet. In particular, the first and second position of contact with the perimeter edge are located at different work heights along a positioning axis transverse to a thickness of the sheet.

The detection member is mounted on a rotating table which is operatively connected to an angular positioning actuator.

Alternatively, always according to the present invention, before or during the detection step, the detection member is selectively positioned linearly in a position of contact with the perimeter edge at a desired work height transverse to the thickness of the sheet.

The desired work height is a work height along a positioning axis transverse to a thickness of the sheet.

In accordance with another aspect of the present invention, the method comprises, before the detection step, an adjustment step in which the position of the detection member is adjusted along an adjustment axis transverse with respect to the direction of advance, on the basis of the thickness and of the position of at least one of the lateral surfaces of the sheet.

### DESCRIPTION OF THE DRAWINGS

These and other aspects, characteristics and advantages of the present invention will become apparent from the following description of some embodiments, given as a non-restrictive example with reference to the attached drawings wherein:

FIG. 1 is an apparatus for working sheets which comprises a position detection unit for a sheet, according to the present invention;

FIG. 2 is a three-dimensional view of an embodiment of the position detection unit of FIG. 1;

FIGS. 3-4 are three-dimensional views of another embodiment of the position detection unit of FIG. 1;

FIG. 5 is a front view of another embodiment of the position detection unit of FIG. 1;

FIG. 6 is a three-dimensional view of another embodiment of the position detection unit of FIG. 1;

FIGS. 7-8 are schematic views which represent the detection member of the position detection unit of FIG. 6 which interferes with a monolithic (FIG. 7) and laminated (FIG. 8) sheet.

We must clarify that in the present description the phraseology and terminology used, as well as the figures in the attached drawings also as described, have the sole function of better illustrating and explaining the present invention, their function being to provide a non-limiting example of the invention itself, since the scope of protection is defined by the claims.

To facilitate comprehension, the same reference numbers have been used, where possible, to identify identical common elements in the drawings. It is understood that elements and characteristics of one embodiment can be conveniently combined or incorporated into other embodiments without further clarifications.

### DESCRIPTION OF SOME EMBODIMENTS OF THE PRESENT INVENTION

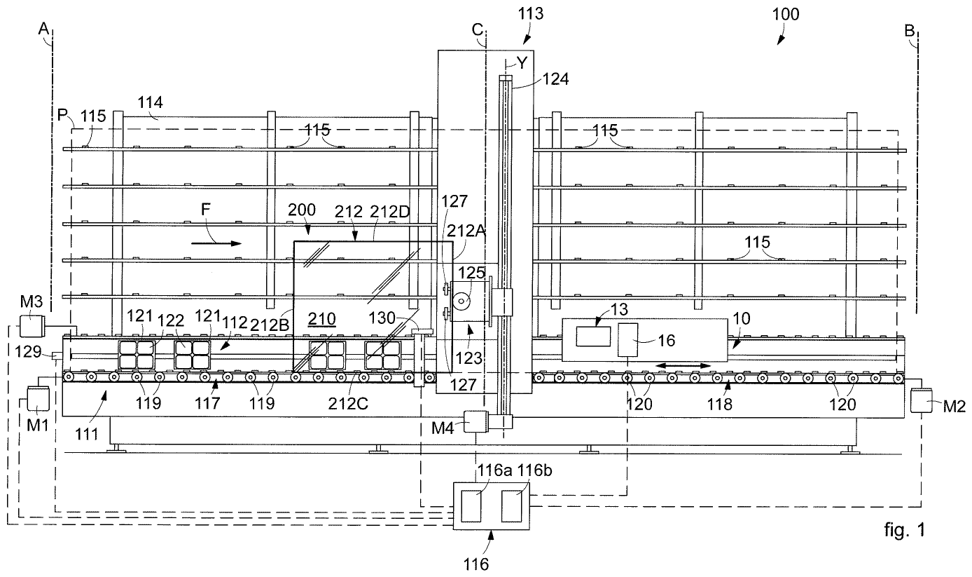

With reference to FIG. 1, this shows an apparatus 100 according to the present invention configured to perform grinding, drilling or milling work on sheets 200, for example, but not exclusively, made of glass. More generally, the sheets 200 can be made of a fragile material having a glass-like behavior.

Each sheet 200 has a first lateral or front surface 210, an opposite second lateral or rear surface 211, and a perimeter edge 212 having a thickness T.

The lateral surfaces 210, 211 are essentially flat and can have a rectangular, circular, elliptical, trapezoidal, polygonal shape, or a combination thereof. At least in the case of a rectangular sheet, the perimeter edge 212 is defined by a front side 212A, an opposite rear side 212B, a lower side 212C and an opposite upper side 212D.

Before undergoing the grinding work, the perimeter edge 212 of each sheet 200, in particular its front side 212A, can be irregular and have at least a first segment, or orthogonal segment, 213 substantially orthogonal to one of the lateral surfaces 210, 211, and at least a second segment, or inclined segment, 214 which is inclined with respect to said lateral surfaces 210, 211. The edge that separates the orthogonal segment 213 with respect to the lateral surface 210, 211 identifies an incision line L, which is the incision line from which the cut is triggered, for example in order to obtain the sheet 200 starting from a sheet of a larger format or simply to shape it.

The incision line L is the reference necessary for the apparatus 100 to guarantee the correct execution of the working, specifically grinding, milling or drilling.

The perimeter edge 212 can however contain localized shape defects, that is, ones that alter the theoretical shape, such as to lead to a relative path between the perimeter edge 212 of the sheet 200 and a work tool 125 that is offset according to the extent of such shape defects.

Moreover, each sheet 200 can be monolithic, that is, made with a single monolithic glass panel, or laminated, if it comprises two monolithic glass panels between which a membrane 215, for example made of plastic material, is disposed. In this case, a monolithic sheet 200 can have a thickness comprised between about 3 mm and about 20 mm; a laminated sheet 200 can have an overall thickness comprised between about 6 mm and about 30 mm.

According to some embodiments, the apparatus 100 comprises an inlet section A in correspondence with which one or more sheets 200 to be worked are supplied to the apparatus 100 manually, or in an automated manner by other apparatuses disposed upstream, and an outlet section B in correspondence with which the worked sheets 200 are evacuated from the apparatus 100 toward other apparatuses disposed downstream.

The apparatus 100 comprises a first movement unit 111 configured to move one or more of the sheets 200 on a work plane P in a direction of advance F, by supporting it and dragging it at the lower part, that is, with respect to the lower side 212C of the perimeter edge 212. In FIG. 1, the direction of advance F goes from the inlet section A to outlet section B.

In the example given here, the work plane P is substantially vertical, in particular slightly inclined by a few degrees, for example by about 6°, with respect to a generic vertical plane. The work plane P is defined by a support wall 114 consisting of a plurality of lines of idle wheels 115 which extend from the inlet section A to the outlet section B, and against which the sheet 200 is rested, for example with respect to its rear lateral surface 211. According to one variant, the work plane P can be horizontal or have any inclination whatsoever with respect to a support plane.

The apparatus 100 also comprises a second movement unit 112 configured to move the sheet 200 on the work plane P in the direction of advance F dragging it laterally, that is, with respect to its first lateral surface 210, that is, the front one, or more advantageously with respect to its second lateral surface 211, that is, the rear one.

Both the first movement unit 111 and also the second movement unit 112 extend from the inlet section A to the outlet section B. Furthermore, the first and second movement unit 111, 112 can be activated simultaneously in order to cooperate in the movement of the same sheet 200, or they can be activated independently.

The apparatus 100 also comprises a work unit 113 disposed in correspondence with an intermediate section C which is positioned between the inlet section A and the outlet section B. The work unit 113 has a vertical or inclined configuration, substantially parallel to the work plane P.

The apparatus 100 comprises a position detection unit 10 configured to detect the orthogonal segment 213 of the perimeter edge 212 of the sheet 100, and therefore the incision line L, so as to obtain a reference for the correct positioning of the sheet 100 with respect to the work unit 113, as will be described in greater detail below. Correctly detecting the position of the orthogonal segment 213, and therefore of the incision line L, allows to use the reference of the incision line L for subsequent working, preventing removing excessive material or performing working with incorrect references, as instead often happens in the state of the art.

Alternatively, the position detection unit 10 can interact with the perimeter edge 212 of the sheet 200 in the transverse position of the most protruding thickness T.

The position detection unit 10 allows to perform the detection favorably even in the case in which localized shape defects are present on the perimeter edge 212.

The apparatus 100 comprises a central control unit 116 configured at least to manage the first movement unit 111, the second movement unit 112, the work unit 113 and the position detection unit 10 in order to guarantee the execution of optimized working on the sheet 100. The central control unit 116 comprises a central processing unit, or CPU, 116a and at least one memory unit 116b connected thereto.

According to some embodiments, the first movement unit 111 comprises an inlet conveyor 117, which extends from the inlet section A to the intermediate section C, and an outlet conveyor 118, which extends from the intermediate section C to the outlet section B.

Each conveyor 117, 118 is equipped with a plurality of rollers 119, 120 driven by means of a respective first motor M1 and second motor M2. The rollers 119, 120 define at the upper part a support surface for the sheet 200 which rests on them with the lower side 212C. As an alternative to the rollers 119, 120, the conveyors 117, 118 can comprise belts, strips, carpets, or similar or comparable movement devices.

The second movement unit 112 extends in a continuous manner from the inlet section A to the outlet section B, and comprises one or more sliders 121 driven by means of a third motor M3 and which are sliding on lateral guides 126.

Each slider 121 is provided with suckers 122 which are connected to a pneumatic circuit commanded to create a vacuum to hold, and a pressure to release, the sheet 200. The suckers 122 are configured to hold the sheet 200 with respect to a lateral surface 210, 211 thereof, advantageously with respect to the rear lateral surface 211.

The contact surface of the suckers 122 can be equipped with suitable sensors configured to detect the position of the lateral surface 210, 211 of the sheet 200 and to send a reference signal to the central control unit 116 which contains the position of the lateral surface 210, 211 from which the thickness T of the sheet 200 will be considered for the subsequent measurements and working.

According to some embodiments, the movement of the sheet 200 can occur in a coordinated and contemporary manner, both by means of the first movement unit 111 and also by means of the second movement unit 112, or it can occur in an independent manner with one or the other of the movement units 111, 112. For example, the first movement unit 111 can be used in the steps of transferring the sheet 200 from the inlet section A to the outlet section B, while the second movement unit 112 can be used to determine the advance of the sheet 200 during working.

The work unit 113 comprises a work head 123 and a guide 124 which develops along a work axis Y and along which the work head 123 is sliding. The guide 124 ends below the support plane defined by the rollers 119, 120 so as to allow the work head 123 to also reach the lower side 212C of the perimeter edge 212 of the sheet 200. The work axis Y extends parallel to the height of the sheet 200.

The movement of the work head 123 along the work axis Y is managed by a fourth motor M4.

The work head 123 has at least one work tool 125 mobile along a registration axis transverse with respect to the work axis Y in order to operate along the entire thickness T of the sheet 200, and a pair of jaws 127 configured to hold and guide the portion of sheet 200 being worked in order to limit vibrations.

According to some embodiments, the work tool 125 can be configured to perform one of either a grinding work of the perimeter edge 212 of the sheet 200, a drilling work of the sheet 200 or a milling work of the sheet 200, the latter two being able to also affect the total thickness T of the sheet 200. By way of example only, the work tool 125 shown in FIG. 1 is a grinding wheel.

The work head 123, or the work tool 125 together with the jaws 127, can also rotate around an orientation axis, orthogonal to the work plane P, so as to orient the jaws 127 and be able to work the entire perimeter edge 212 of the sheet 200.

The apparatus 100 comprises, in correspondence with the inlet section A, a measuring device 129 configured to measure the thickness T of the sheet 200 and to send a corresponding measurement signal to the control unit 116 so that the datum relating to the thickness T measured can be stored in the memory unit 116b.

The apparatus 100 comprises, immediately upstream of the intermediate section C, one or more proximity sensors 130 configured to detect the arrival of the sheet 200 and to send a corresponding proximity signal to the control unit 116 which, in turn, generates a command signal and sends it to the motors M1-M3 in order to cause the slowing down or interruption of the movement of the sheet 200.

According to some embodiments, the position detection unit 10 comprises a slider 11 able to be selectively moved in the direction of advance F in both senses, and specifically both toward the inlet section A and also toward the outlet section B of the apparatus 100.

The slider 11 can be provided with idle wheels 36, with a function similar to the idle wheels 115, in order to allow the sheet 200 to be rested sliding.

The slider 11 of the position detection unit 10 can be mounted on the same lateral guide 126 on which the sliders 121 of the second movement unit 112 are mounted, or on its own independent guide, distinct and separate from the lateral guide 126.

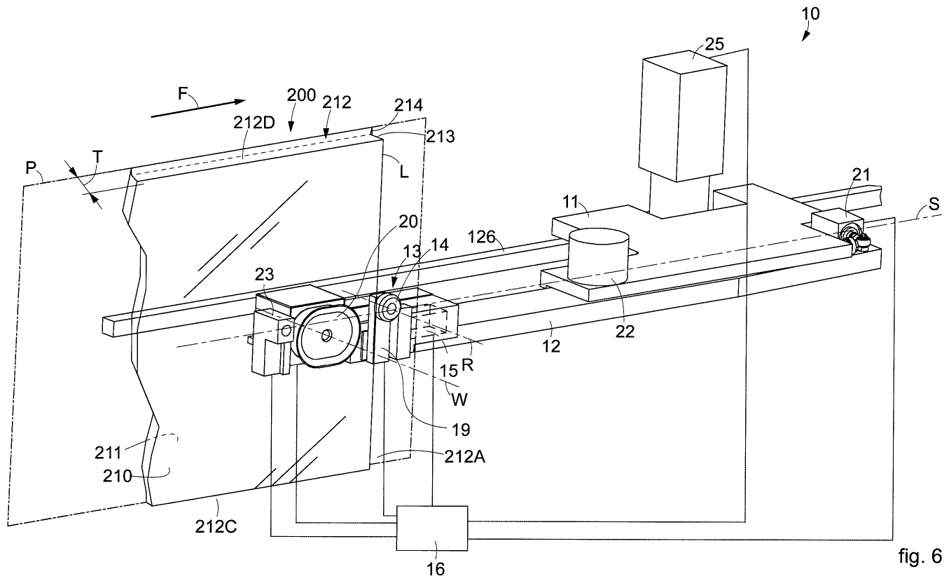

With particular reference to FIG. 6, the position detection unit 10 comprises a pinion-rack movement mechanism, actuated by a motor 25, which allows the movement of the slider 11 on the lateral guide 126 or on another guide distinct from the lateral guide 126 of the apparatus 100. However, other types of movement mechanisms known to the persons of skill in the art are not excluded.

According to one variant, the slider 11 can be disposed in a fixed position on the apparatus 100.

The position detection unit 10 comprises a detection device 13 configured to temporarily interfere with the perimeter edge 212 of the sheet 200.

In particular, the detection device 13 comprises a support body 19 and a detection member 14 associated with the support body 19 and configured to come into contact with the perimeter edge 212 of the sheet 200. As will be described below, the support body 19 can also consist of a component such as an actuator.

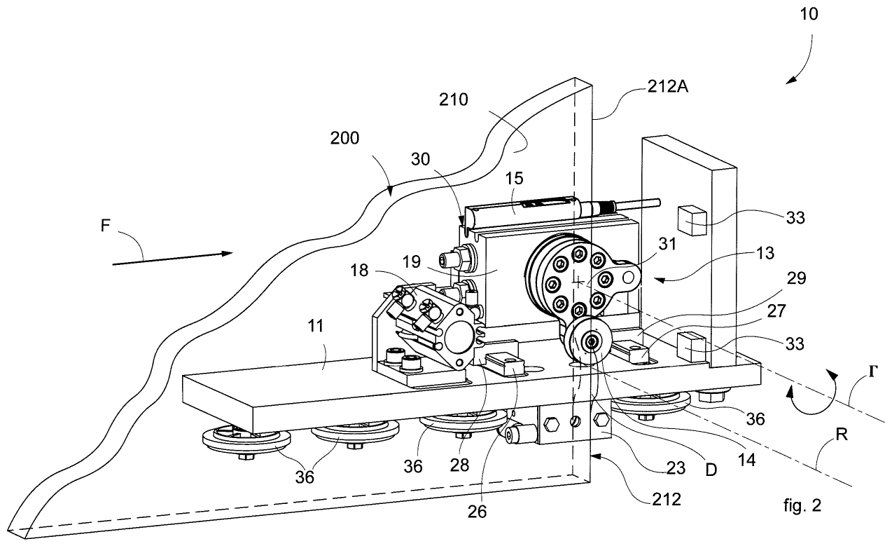

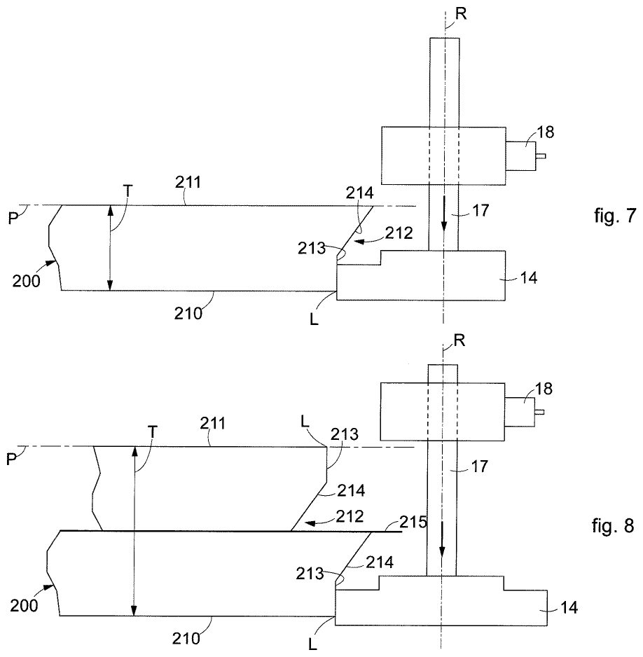

According to some embodiments, the detection member 14 can be or comprise a wheel (FIGS. 2-5 and FIG. 8), a block (FIG. 7), or other similar or comparable element.

The detection device 13 can be able to be selectively moved along an adjustment axis R transverse with respect to the direction of advance F, for example as shown in FIGS. 2-8. The adjustment axis R is substantially orthogonal to the direction of advance F of the sheet 200 and to the work plane P.

The movement of the detection device 13 along the adjustment axis R has the purpose of taking the detection member 14 into position with respect to the thickness T of the sheet 200 and to the position of at least one of the lateral surfaces 210, 211, advantageously of the front one 210, in order to correctly detect the position of the perimeter edge 212 of the sheet 200.

Alternatively or in addition, the detection member 14 itself is able to be selectively moved along the adjustment axis R with respect to the support body 19, see FIGS. 6-8.

The position detection unit 10 also comprises a transverse positioning actuator 18 operatively connected to the detection device 13 and configured to move the latter, or the detection member 14, along the adjustment axis R, FIG. 2-5 and FIGS. 7 and 8.

According to the embodiment of FIGS. 2-4, the position detection unit 10 is provided with guides 26, 27 attached to the slider 11 and with corresponding sliding blocks 28, 29 attached to the support body 19 to allow its sliding and consequently the movement of the detection device 13 along the adjustment axis R.

According to the embodiment of FIGS. 7 and 8, the detection member 14 is supported by a rod 17 moved by the transverse positioning actuator 18.

The detection device 13 also comprises a transducer member 15 operatively associated with the detection member 14 and activated by the latter to send a position reference signal to the central control unit 116 of the apparatus 100.

According to some embodiments, the position detection unit 10 can optionally comprise its own control unit 16, configured at least to manage the movement of the detection device 13 or of the detection member 14 and to receive the reference signal sent by the transducer member 15. The control unit 16 can be configured to interact with the central control unit 116 of the apparatus 100 in order to receive at least the information relating to the thickness T of the sheet 100 previously measured by the measuring device 129 and stored in the memory unit 116b or already contained in the latter, since it comes from a management information system where it is possible to record the data relating to the sheets 200 to be worked, and information relating to the position of at least one of the two lateral surfaces 210, 211 of the sheet 100 deriving from the measurement carried out by the sensors present on the suckers 122 of the second movement unit 112.

The transverse positioning actuator 18 is driven by the control unit 16, or by the central control unit 116, at least on the basis of the measurement of the thickness T and on the basis of the position reference relating to the lateral surface 210, 211 so as to position the detection member 14 in correspondence with the orthogonal segment 213 of the perimeter edge 212 of the sheet 200. Positioned in this way, the detection member 14 is able to measure the position of the incision line L exactly.

The detection device 13, in particular the support body 19, can be able to be selectively moved in order to position the detection member 14 at different work heights along the perimeter edge 212 of the sheet 200, for example in the event the perimeter edge 212 contains a shape defect. The work height is defined in a direction in which the height of the sheet 200 extends.

According to one variant, the detection member 14 itself can be able to be selectively moved with respect to the support body 19 in order to move to different work heights along the perimeter edge 212 of the sheet 200.

With both solutions it is possible to perform the detection of the incision line L, or in general of the perimeter edge 212, in the position in which it correctly describes the trend of the profile, that is, in a position without shape defects.

According to some embodiments, the position detection unit 10 comprises an angular positioning actuator 30 with which the detection member 14 is associated.

In the examples of FIGS. 2-4, the angular positioning actuator 30 acts as a support body 19.

The detection member 14 is mounted in an eccentric position on a rotating table 31 which is part of the angular positioning actuator 30 or is attached to a rotating part of the latter.

The rotating table 31 is rotatable around a rotation axis I which coincides, or is parallel, if present, to the adjustment axis R.

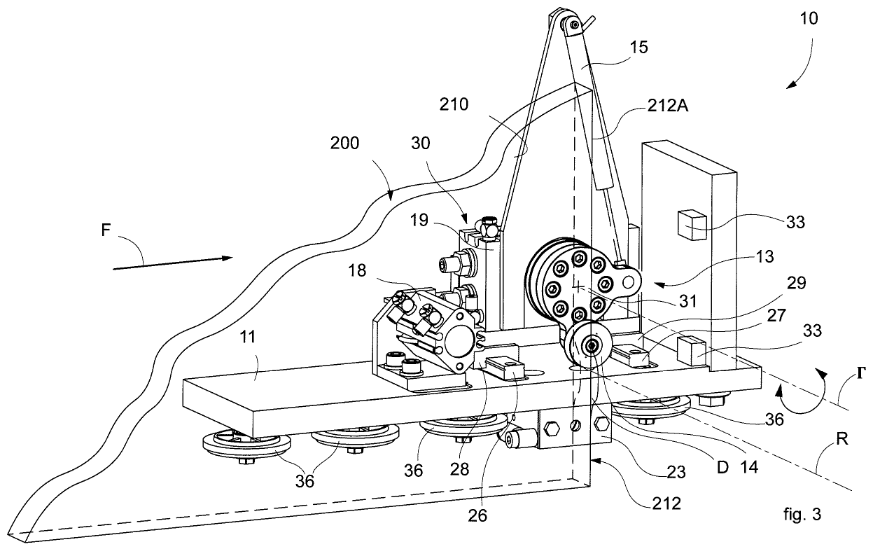

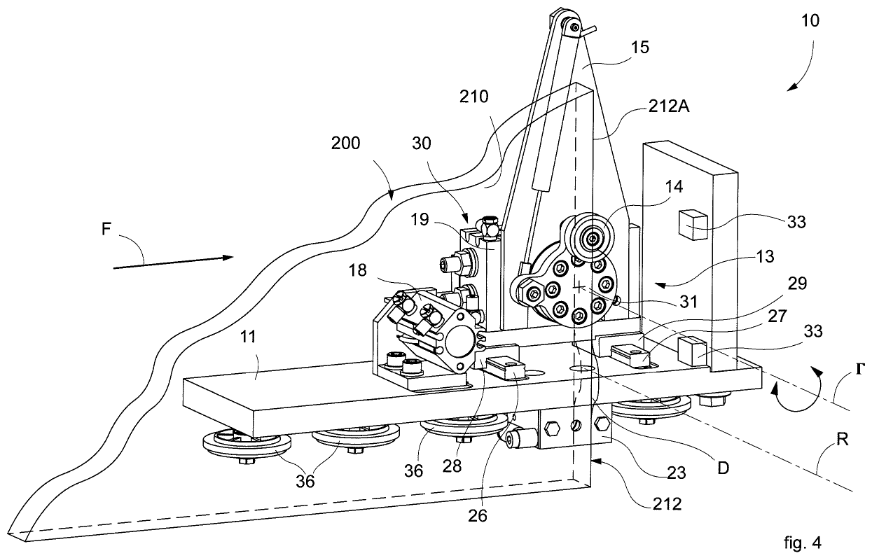

The controlled rotation of the rotating table 31 allows to position the detection member 14 in a first (FIG. 3) or in a second (FIG. 4) position of contact with the perimeter edge 212 of the sheet 200. If in the first contact position there is a defect or imperfection D which would make the measurement of the position of the sheet 200 incorrect, then the rotating table 31 is rotated in order to position the detection member 14 in the second contact position.

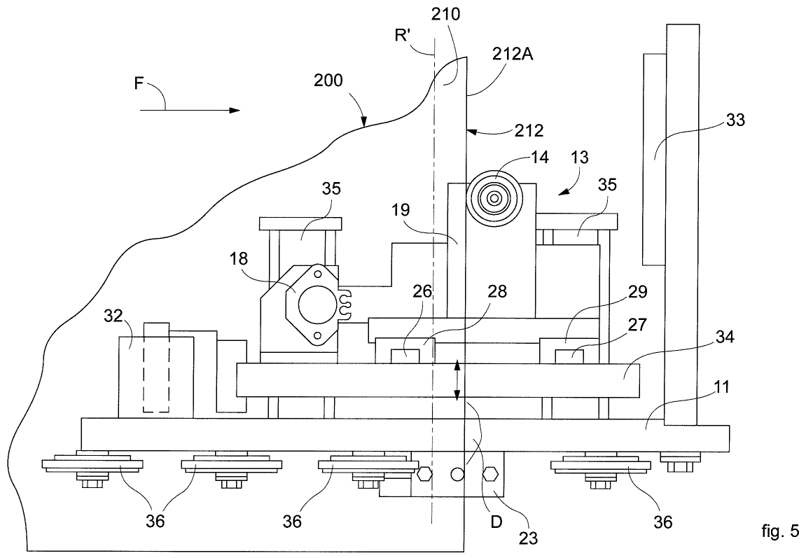

According to another embodiment shown in FIG. 5, the detection device 13, in particular the support body 19, or the detection member 14 are able to be selectively moved linearly along a positioning axis R′ in a plurality of positions of contact of the detection member 14 with the perimeter edge 212 of the sheet 200. In this case, the detection member 14 is moved according to a continuous displacement mode into more than two possible contact positions, offering a continuous and more extensive field for the away movement from the portions of the perimeter edge 212 altered by local imperfections D.

The detection member 14 is always oriented toward the sheet 200 and the variation of position with respect to the latter occurs linearly. The positioning axis R′ is orthogonal to the adjustment axis R, having a substantially vertical direction with reference to the correctly and normally installed position detection unit 10. The positioning axis R′ is transverse with respect to the thickness T of the sheet 200, therefore it can be said that it extends in the direction of the height of the sheet 200.

The position detection unit 10 also comprises a linear positioning actuator 32 operatively connected to the detection device 13 and configured to move the latter along the positioning axis R′. In the example of FIG. 5, the detection device 13 is mounted on a plate 34 sliding on guides 35 which are parallel to the positioning axis R′.

The position detection unit 10 also comprises detection means, which in the present case are one or more proximity sensors 23, configured to detect the arrival of the sheet 200 and to send a corresponding proximity signal to the control unit 16 or directly to the central control unit 116, which in turn generates and sends a command signal to the motors M1-M3 so that the latter provide to slow down and then interrupt the movement of the sheet 200.

The one or more proximity sensors 23 are disposed upstream of, or at most in correspondence with, the detection device 13 with respect to the direction of advance F from which the sheet 200 arrives.

According to some embodiments, the angular positioning actuator 30, on the basis of a correction signal generated by the control unit 16 or directly by the central control unit 116, can allow a corrective angular oscillation of the detection member 14 in order to correct the inaccurate positioning of the glass sheet 200, based on the proximity signal of the proximity sensor 23.

According to some embodiments, the position detection unit 10 can comprise image acquisition devices 33 positioned at the work height of the detection member 14, for example at the lower and upper work heights which correspond to the contact positions of the detection member 14, or covering the whole range of travel of the detection member 14, and able to identify whether the perimeter edge 212 of the sheet 200 is regular or compromised by shape defects.

Likewise, the information on the presence of shape defects and therefore the need to switch, or displace, the detection member 14, can be entered manually by the operator, through an operator interface connected to the central control unit 116 which operates, subsequently, the command of the angular positioning actuator 30.

Alternatively, the command of the angular positioning actuator 30 can be managed in an automatic manner by the central control unit 116 on the basis of the images detected by the image acquisition devices 33.

The position detection unit 10 can also comprise at least one sucker 20 configured to hold the sheet 200 during the detection of the orthogonal segment 213 or of the perimeter edge 212, and/or to hold the sheet 200 in the event that the slider 11 of the position detection unit 10, after the possible detection of the orthogonal segment 213 or the perimeter edge 212, is used to position the sheet 200 itself with respect to the work tool 125.

The at least one sucker 20 is disposed upstream of the detection device 13 with respect to the direction of advance F from which the sheet 200 arrives.

The sucker 20 can be moved from a gripping position in which it is close to the sheet 200, to a retracted position in which it is disposed in a position away from the sheet 200. The movement of the sucker 20 can occur along a gripping axis W parallel to the adjustment axis R.

According to the embodiments of FIGS. 2-5, the detection device 13, the one or more proximity sensors 23 and the sucker 20, if present, are associated with the slider 11.

According to the embodiment shown in FIG. 6, the position detection unit 10 comprises a support arm 12 associated with the slider 11 and having a prevalent extension along its own development axis S which is substantially parallel to the direction of advance F.

The support arm 12 is terminally provided with the detection device 13 which projects transversally from the support arm 12.

The support arm 12 is rotatably associated with the slider 11 by means of a pin 22. In particular, the support arm 12 is pivoted to the slider 11 in order to pass from an interfering position, in which at least the detection member 14 is in a position such as to be able to interfere with the sheet 200, to a non-interfering position, in which the support arm 12 is positioned in such a way as to allow the sheet 200 to go beyond, without obstacle, the position detection unit 10 in the direction of advance F.

The support arm 12 comprises a first terminal portion on which, in addition to the detection device 13, the at least one sucker 20 is also mounted.

The one or more proximity sensors 23 can also be mounted on the first terminal portion of the support arm 12.

The support arm 12 comprises a second terminal portion, opposite to the first, and on which a pneumatic actuator 21 is mounted having one part attached to the support arm 12 and one part attached to the slider 11 so as to activate, according to requirements, the rotation of the support arm 12. The pneumatic actuator 21 can be controlled by the control unit 16 of the position detection unit 10 or by the central control unit 116 of the apparatus 100.

The operation of the position detection unit 10, which corresponds to the method according to the present invention, comprises the following steps:
a movement step, in which a sheet 200 is made to advance in the direction of advance F toward the position detection unit 10, or vice versa;
a detection step, in which the detection member 14 is taken to temporarily interfere with the perimeter edge 212 of the sheet 200.

When the position detection unit 10 is installed on the apparatus 100, a preferred solution is to initially move the sheet 200 with the first movement unit 111 until it stops or slows down in proximity to the work unit 113, thanks to the proximity sensor 130. The movement of the sheet 200 is then continued, with the second movement unit 112 by means of the suckers 122, until the front side 212A of the perimeter edge 212 of the sheet 200, possibly and in particular the orthogonal segment 213 of the perimeter edge 212 which, having a development that is orthogonal to the lateral surfaces 210, 211, identifies the incision line L from which the cut of the glass sheet departs, is taken in proximity to the position detection unit 10.

Preferably, the sheet 200 is rested on the work plane P with respect to the lateral surface 210, 211 which does not contain the incision line L (except for the redundant situation of the sheet of laminated glass). In other words, the incision line L, useful for the position detection unit 10, is located on the free front lateral surface 210.

The movement of the sheet with the second movement unit 112 by means of the suckers 122 allows to obtain the reference relating to the position of the rear lateral surface 211 which is transmitted to the control unit 16 of the position detection unit 10 in order to command the adjustment of the detection member 14 along the adjustment axis R.

Before the sheet 200 reaches the proximity sensors 130 and 23, the following three steps are implemented, the first two not necessarily in order.
Step 1. The transverse positioning actuator 18 is actuated in order to operate the transverse displacement of the detection member 14 along the adjustment axis R, by means of the sliding of the sliding blocks 28, 29 on the guides 26, 27, so that it can subsequently interfere with the perimeter edge 212 of the sheet 200.
Step 2. As a function of the selection of the contact position of the detection member 14, first or second contact position based on the presence of defects, the angular positioning actuator 30 is driven, at a pressure value pl, to obtain the desired position, through the command of a solenoid valve for the pressurization of the corresponding chamber.
Step 3. The pressure of the chamber is then switched from the pressure value p1 to a pressure value p2, lower than the pressure value p1, a value which is selected to an order of magnitude such as not to damage the perimeter edge 212 of the sheet 200, but at the same time such as to guarantee reciprocal contact.

Subsequently, the sheet 200 is moved in the direction of advance F so that, after the steps of slowing down and stopping determined by the proximity sensors 130 and 23, respectively, the perimeter edge 212 of the sheet 200 causes a slight movement of the detection member 14, the position of which is identified by the transducer member 15 which transmits a reference signal to the control unit 16 or directly to the central control unit 116. The central control unit 116 can therefore govern the displacements of the sheet 200 in the direction of advance, also in back and forth mode, relative to the work tool 125. The sheet 200 can be positioned with respect to the work tool 125 by means of the second movement unit 112 or by means of the sucker 20 and the movement of the slider 11 of the position detection unit 10 in the direction of advance F toward the tool 125.

Once its function has ended, the position detection unit 10 can advance to the outlet section B of the apparatus 100 in order to leave the lateral guide 126, if shared with that of the sliders 121, free for the latter to slide, or maintain the position.

It is clear that modifications and/or additions of parts may be made to the unit 10 and to the method for detecting the position of a sheet 200 and to the apparatus 100 for working sheets 200 comprising said position detection unit 10 as described heretofore, without departing from the field and scope of the present invention, as defined by the claims.

It is also clear that, although the present invention has been described with reference to some specific examples, a person of skill in the art will be able to achieve other equivalent forms of position detection unit 10, corresponding position detection method and apparatus 100 for working sheets 200 having the characteristics as set forth in the claims and hence all coming within the field of protection defined thereby.

In the following claims, the sole purpose of the references in brackets is to facilitate their reading and they must not be considered as restrictive factors with regard to the field of protection defined by the claims.

1. A positional detector for a sheet having a perimeter edge, the positional detector comprising:
a slider;
a detection device comprising a detection member,
an angular positioning actuator; and
a rotating table operatively connected to the angular positioning actuator, wherein:
the detection member is mounted on the rotating table, and
the detection member is selectively positionable angularly in a first position and a second position of contact with the perimeter edge at different work heights along a positioning axis transverse to a thickness of the sheet.

2. A positional detector for a sheet having a perimeter edge, the positional detector comprising:
a slider;
a detection device comprising a detection member; and
a linear positioning actuator to which the detection device is connected,
wherein the detection member is selectively positionable linearly in a position of contact with the perimeter edge at a work height along a positioning axis transverse to a thickness of the sheet.

3. The positional detector of claim 1, wherein the detection device or the detection member is configured to be selectively moved along an adjustment axis transverse to a direction of advancement of the sheet.

4. The positional detector of claim 3, further comprising guides attached to the slider and sliding blocks attached to the detection device, the sliding blocks being parallel to the adjustment axis.

5. The positional detector of claim 1, further comprising a detection-means upstream of the detection device and configured both to detect arrival of the sheet and to detect a distance between the perimeter edge and the detection member.

6. The positional detector of claim 5, further comprising a control unit configured to control movement of the detection member based on a thickness of the sheet, a position of at least one lateral surface of the sheet, or detection signals generated by the detection means.

7. The positional detector of claim 6, wherein the angular positioning actuator is configured to determine a corrective angular commutation of the detection member based on a correction signal generated by the control unit.

8. The positional detector of claim 6, further comprising at least one image acquisition device in communication with the control unit and configured to acquire and send images of the perimeter edge facing the detection member to the control unit.

9. An apparatus for working a sheet having a perimeter edge, the apparatus comprising:
a mover configured to move at least one sheet at a time in a direction of advance;
a work tool configured to work on the at least one sheet; and
the positional detector of claim 1 configured to detect the position of the at least one sheet.

10. A method for detecting the position of a sheet having a perimeter edge, the method comprising:
advancing a sheet relative to the positional detector of claim 1; and
detecting, using the detection member, a temporary interference with the perimeter edge of the sheet.

11. A method for detecting the position of a sheet having a perimeter edge, the method comprising:
advancing a sheet relative to the positional detector of claim 2; and
detecting, using the detection member, a temporary interference interfere with the perimeter edge of the sheet.

12. The method of claim 10, further comprising adjusting the position of the detection member along an adjustment axis transverse to a direction of advance and of the position of at least one lateral surface of the sheet.

13. The positional detector of claim 8, wherein the control unit is configured to process the images, to identify irregularities or defects based on the images, and to command movement of the detection member.

14. The method of claim 11, further comprising adjusting the position of the detection member along an adjustment axis transverse to a direction of advance and of the position of at least one lateral surface of the sheet.

15. The positional detector of claim 2, wherein the detection device or the detection member is configured to be selectively moved along an adjustment axis transverse to a direction of advancement of the sheet.

16. The positional detector of claim 15, further comprising guides attached to the slider and sliding blocks attached to the detection device, the sliding blocks being parallel to the adjustment axis.

17. The positional detector of claim 2, further comprising a detection means upstream of the detection device and configured both to detect arrival of the sheet and to detect a distance between the perimeter edge and the detection member.

18. The positional detector of claim 17, further comprising a control unit configured to control movement of the detection member based on a thickness of the sheet, a position of at least one lateral surface of the sheet, or detection signals generated by the detection means.

19. The positional detector of claim 18, further comprising at least one image acquisition device in communication with the control unit and configured to acquire and send images of the perimeter edge facing the detection member to the control unit.

20. The positional detector of claim 19, wherein the control unit is configured to process the images, to identify irregularities or defects based on the images, and to command movement of the detection member.

21. An apparatus for working a sheet having a perimeter edge, the apparatus comprising:
a mover configured to move at least one sheet at a time in a direction of advance;
a work tool configured to work on the at least one sheet; and
the positional detector of claim 2 configured to detect the position of the at least one sheet.
